(19) United States
(12) Patent Application Publication
(10) Pub. No.: US 2005/0281316 A1
(43) Pub. Date: Dec. 22, 2005

(54) Method for transmitting/receiving operation mode information in a broadband wireless access communication system

(75) Inventors: Ji-Ho Jang, Seoul (KR); Jae-Ho Jeon, Seongnam-si (KR); Seung-Joo Maeng, Seongnam-si (KR); Ik-Beom Lee, Seongnam-si (KR); Jae-Hyok Lee, Seoul (KR); Soon-Young Yoon, Seoul (KR); Pan-Yuh Joo, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/157,525

(22) Filed: Jun. 21, 2005

(30) Foreign Application Priority Data
Jun. 21, 2004 (KR) 46320/2004
Jun. 24, 2004 (KR) 47902/2004
Jul. 30, 2004 (KR) 60568/2004

(51) Int. Cl. H04B 1/69

(52) U.S. Cl. 375/130

(57) ABSTRACT

A method for transmitting/receiving operation mode information in a broadband wireless access (BWA) communication system is disclosed. A transmission side maps a predetermined preamble pattern to an operation mode, and upon a change in operation mode, transmits a preamble pattern corresponding to the changed operation mode. A reception side receives the preamble pattern, detects an operation mode and a preamble code mapped to the preamble pattern, and acquires information from a frame section received according to the operation mode.

### PRIORITY

This application claims priority under 35 U.S.C. § 119 to an application entitled “Method for Transmitting/Receiving Operation Mode Information in a Broadband Wireless Access Communication System” filed in the Korean Intellectual Property Office on Jun. 21, 2004 and assigned Serial No. 2004-46320, an application entitled “Method for Transmitting/Receiving Operation Mode Information in a Broadband Wireless Access Communication System” filed in the Korean Intellectual Property Office on Jun. 24, 2004 and assigned Serial No. 2004-47902, and an application entitled “Method for Transmitting/Receiving Operation Mode Information in a Broadband Wireless Access Communication System” filed in the Korean Intellectual Property Office on Jul. 30, 2004 and assigned Serial No. 2004-60568, the contents of all of which are incorporated herein by reference.

### BACKGROUND OF THE INVENTION

1. Field of the Invention

The present invention relates generally to a method for determining and detecting an operation mode in a Broadband Wireless Access (BWA) communication system, and in particular, to a method for transmitting/receiving operation mode information in a BWA communication system using an Orthogonal Frequency Division Multiple Access (OFDMA) scheme.

2. Description of the Related Art

A mobile communication system using cellular communication technology is a typical wireless communication system. Such a mobile communication system uses a multiple access scheme to perform simultaneous communication with a plurality of users. The typical multiple access schemes used in mobile communication systems include a Time Division Multiple Access (TDMA) scheme and a Code Division Multiple Access (CDMA) scheme. With the rapid progress of the CDMA technology, CDMA systems are developing from a voice communication system into a system capable of transmitting packet data at high speeds.

However, the CDMA scheme suffers difficulty in transmitting increasing amounts of multimedia data due to limited code resources. Therefore, a BWA communication system using an OFDMA scheme is capable of distinguishing the increased number of users and transmitting the increasing amounts of data. The OFDMA scheme transmits and receives data at high speeds using a plurality of orthogonal subcarriers, or, a subchannel with at least one subcarrier.

For high-speed data transmission, the BWA communication system using the OFDMA scheme has been proposed. Many attempts have been made to provide a high-speed wireless Internet service using the OFDMA scheme. The BWA communication system using the OFDMA scheme presents various operation modes, each of which are described below.

A subchannel is configured with one of the following four schemes: a Partial Usage of Sub-Channel (PUSC) scheme, a Full Usage of Sub-Channel (FUSC) scheme, an Optional FUSC scheme, and an Adaptive Modulation Coding (AMC) scheme.

In addition, there are four channel-coding schemes: a Convolutional Coding (CC) scheme, a Convolutional Turbo Coding (CTR) scheme, a Block Turbo Coding (BTC) scheme, and a Zero Tail Convolutional Coding (ZTCC) scheme.

A brief description of the subchannel configuration schemes will be made herein below.

(a) PUSC scheme: configures a subchannel using only a part of subcarriers allocated for data in a full frequency band.

(b) FUSC scheme: configures a subchannel using all of subcarriers allocated for data in the full frequency band.

(c) Optional FUSC scheme: similar to the FUSC except for the formula used to configure a subchannel.

(d) AMC scheme: configures a subchannel by dividing the full frequency band into adjacent bands.

FIG. 1 is a diagram illustrating an example of an operation mode of a downlink frame in a general BWA communication system. Referring to FIG. 1, a downlink frame includes a preamble and a frame control header (FCH) following the preamble. The FCH carries subchannel configuration schemes that are transmitted for a downlink frame period. In FIG. 1, the subchannel configuration schemes include a PUSC scheme, a FUSC scheme, an optional FUSC scheme and an AMC scheme.

The FCH transmits frame control information, a position of uplink/downlink MAP, and subchannel configuration and channel-coding schemes of the MAP. Before decoding the FCH, it is information on the next transmission symbols cannot be acquired, and data decoding is disabled. As a result, the FCH uses predefined subchannel configuration schemes and channel-coding schemes. After the FCH is decoded according to such a rule, the next transmission downlink/uplink MAP information is decoded.

Generally, for data communication, one of the subchannel configuration schemes is selected during the initial transmission of the FCH. Actually, it is provided that among the various operation modes described above, only one fixed operation mode is available at the start of a downlink after a preamble. That is, it is specified that only one fixed operation mode is available for first several symbols of a downlink over which frame control information is transmitted.

The current BWA communication system provides that for an FCH and a downlink/uplink MAP, a subchannel is configured with the PUSC scheme and the convolutional coding scheme is used as the channel-coding scheme.

The limitation to having one fixed operation mode at the start of the downlink after the preamble is that it reduces the efficiency of design and operation of a system. In some cases, a service provider or developer cannot use an initial subchannel configuration scheme and an initial channel-coding scheme in a particular system. However, the current BWA communication system suffers an unnecessary waste of resources due to the limitation in operation modes.

If an initial operation mode for the FCH is not defined or unknown, symbols for the FCH cannot be decoded. In this case, it is not possible to determine a subchannel configuration scheme and a channel-coding scheme for the next transmission data symbols, thus disabling decoding of the data symbols. Therefore, there is a demand for a method of determining and detecting an operation mode, and preventing waste of resources resulting from operation of a system in the above-described operation modes.

### SUMMARY OF THE INVENTION

It is, therefore, an object of the present invention to provide an operation mode information transmission/reception method capable of using various operation modes in a Broadband Wireless Access (BWA) communication system.

It is another object of the present invention to provide an operation mode information transmission/reception method that is flexibly applicable to the design and operation of a BWA communication system.

According to one aspect of the present invention, there is provided a method for transmitting/receiving operation mode information in a broadband wireless access (BWA) communication system. The method comprises the steps of: mapping a predetermined preamble pattern to an operation mode, and upon a change in the operation mode, transmitting a preamble pattern corresponding to the change; receiving the preamble pattern, detecting the operation mode and a preamble code mapped to the preamble pattern, and acquiring information from a frame section received according to the operation mode.

According to another aspect of the present invention, there is provided a method for transmitting operation mode information in a broadband wireless access (BWA) communication system. The method comprises the steps of: predetermining a group of preamble pattern by cyclic-shifting a preamble signal in a time domain; selecting one of the predetermined preamble pattern according to an operation mode and mapping to the operation mode; generating a preamble using the selected preamble pattern; and transmitting the preamble.

According to further another aspect of the present invention, there is provided a method for receiving operation mode information in a broadband wireless access (BWA) communication system. The method comprises the steps of: receiving a preamble and performing a fast Fourier transform on the preamble; detecting an operation mode by extracting a phase variation from a preamble code obtained by cyclic-shifting a preamble pattern in a time domain; and detecting a preamble code, and acquiring information from a frame section using the operation mode and the preamble code.

According to yet further another aspect of the present invention, there is provided a method for transmitting operation mode information in a broadband wireless access (BWA) communication system. The method comprises the steps of: predetermining a group of preamble pattern by cyclic-shifting a preamble signal in a frequency domain; selecting one of the predetermined preamble pattern according to an operation mode and mapping to the operation mode; generating a preamble using the selected preamble pattern; and transmitting the preamble.

According to still another aspect of the present invention, there is provided a method for receiving operation mode information in a broadband wireless access (BWA) communication system. The method comprises the steps of: receiving a preamble and performing a fast Fourier transform on the received preamble; detecting an operation mode by extracting a phase variation from a preamble code obtained by cyclic-shifting a preamble pattern in a frequency domain; and detecting a preamble code, and acquiring information from a frame section using the operation mode and the preamble code.

According to still another aspect of the present invention, there is provided a method for transmitting operation mode information in a broadband wireless access (BWA) communication system. The method comprises the steps of: selecting one of the predetermined a preamble pattern through phase shifting; selecting the preamble pattern according to an operation mode and mapping the operation mode; generating a preamble using the selected preamble pattern; and transmitting the preamble.

According to still another aspect of the present invention, there is provided a method for receiving operation mode information in a broadband wireless access (BWA) communication system. The method comprises the steps of: detecting an operation mode by receiving a preamble and extracting a phase variation of a preamble pattern; restoring a phase of the preamble pattern; and detecting a preamble code by performing a fast Fourier transform on the phase-restored preamble pattern, and acquiring information from a frame section using the operation mode and the preamble code.

According to still another aspect of the present invention, there is provided a method for transmitting operation mode information in a broadband wireless access (BWA) communication system. The method comprises the steps of: generating a group of preamble pattern by performing an inverse fast Fourier transform on a pseudo-random noise (PN) sequence configured in a frequency domain; selecting a preamble pattern according to an operation mode and mapping the determined preamble pattern to the operation mode; generating a preamble using the selected preamble pattern; and transmitting the preamble.

According to still another aspect of the present invention, there is provided a method for receiving operation mode information in a broadband wireless access (BWA) communication system. The method comprises the steps of: receiving a preamble and performing a fast Fourier transform on the received preamble; detecting a preamble code and an operation mode by extracting a pseudo-random noise (PN) sequence constituting a preamble pattern; and acquiring information from a frame section received according to the operation mode using the operation mode and the preamble code

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram illustrating an example of an operation mode of a downlink frame in a general BWA communication system;

FIG. 2 shows a diagram illustrating an example of an operation mode of a downlink frame in a BWA communication system according to an embodiment of the present invention;

FIG. 3 shows a flowchart illustrating an operation of detecting an initial operation mode and performing data decoding on the next transmission symbols in a BWA communication system according to an embodiment of the present invention;

FIG. 4 shows a diagram for a description of a method for configuring a preamble in a BWA communication system according to an embodiment of the present invention;

FIG. 5 shows a diagram for a description of a method for configuring a preamble in a BWA communication system according to an embodiment of the present invention;

FIG. 6 shows a flowchart illustrating an operation of detecting by a mobile station an operation mode from a preamble configured using time and frequency domains in a BWA communication system according to an embodiment of the present invention;

FIG. 7A shows a diagram illustrating an example of a method for mapping preamble signals to subcarriers according to an alternative embodiment of the present invention;

FIG. 7B shows a diagram illustrating a method for configuring a preamble in a BWA communication system according to an alternative embodiment of the present invention;

FIG. 8A shows a diagram illustrating an example of a method for mapping preamble signals to subcarriers according to an alternative embodiment of the present invention;

FIG. 8B shows a diagram illustrating a method for configuring a preamble in a BWA communication system according to an alternative embodiment of the present invention;

FIG. 9 shows a flowchart illustrating an operation of detecting by a mobile station an operation mode from a preamble pattern configured by phase-shifting the preamble pattern in a BWA communication system according to an alternative embodiment of the present invention; and

FIG. 10 shows a flowchart illustrating an operation of detecting by a mobile station an operation mode using PN sequences in a BWA communication system according to a further alternative embodiment of the present invention.

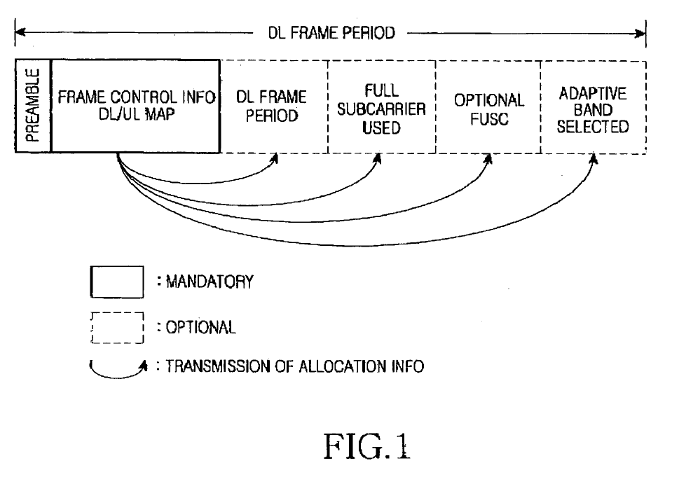

### DETAILED DESCRIPTION OF THE PREFERRED EMBODIMENT

Several preferred embodiments of the present invention will now be described in detail with reference to the annexed drawings. In the drawings, the same or similar elements are denoted by the same reference numerals even though they are depicted in different drawings. In the following description, a detailed description of known functions and configurations incorporated herein has been omitted for conciseness.

The present invention provides a method for carrying information on one of several optional operation modes rather than a fixed initial operation mode, on a preamble of every downlink, the preamble being transmitted first in its respective downlink. In this manner, the present invention presents a technique capable of acquiring basic system parameters without designating a mandatory operation mode.

The initial operation mode of a system according to an embodiment of the present invention can inform the reception side of the operation mode using a preamble. Information bits for the operation mode do not modify or manipulate the preamble in the existing BWA communication system. Therefore, the information bits for the operation mode can be added to the codes used in the current BWA communication system.

For example, the additional information bits may be transmitted by cyclic-shifting each of the preamble signals in a frequency domain at predetermined intervals or cyclic-shifting each of the preamble signals in a time domain by a predetermined time. Alternatively, the additional information may be transmitted by phase-shifting a time-domain preamble pattern occurring when converting each of frequency-domain preamble signals into a time-domain signal through inverse fast Fourier transform (IFFT). Further alternatively, the additional information transmission is possible by using a pseudo-random noise (PN) sequence configured in a frequency domain as a preamble signal through IFFT.

The present invention transmits an initial operation mode of an OFDMA-based BWA communication system through an initial transmission preamble. Therefore, the present invention is not necessarily required to use an initial operation mode PUSC which is mandatory in the current BWA communication system, and can selectively use one of various initial operation modes according to a service provider or developer. The flexible application of the initial operation modes can reduce inefficiency and waste of resources.

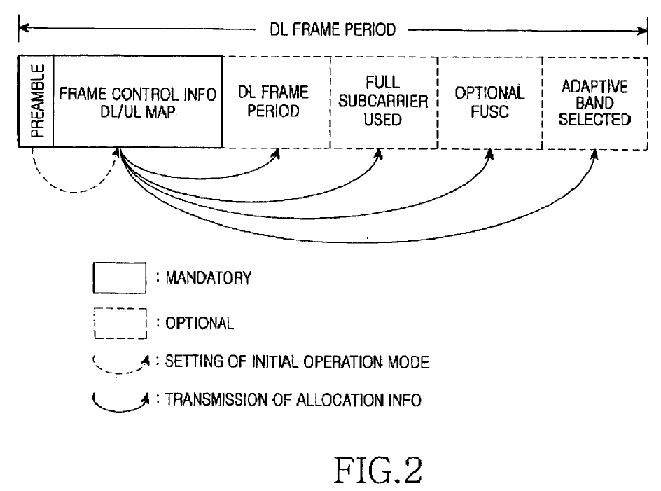

FIG. 2 is a diagram illustrating an example of an operation mode of a downlink frame in a BWA communication system according to an embodiment of the present invention. Referring to FIG. 2, the operation mode of the novel downlink frame is different from the operation mode of the existing downlink frame in terms of the part for setting an initial operation mode. Therefore, in the downlink frame of FIG. 2, it is possible to designate a subchannel configuration scheme and a channel-coding scheme for a frame control header (FCH) using a preamble. In addition, a description will be made of a novel scheme for designating a subchannel configuration scheme and a channel-coding scheme for a FCH using the preamble.

The present invention can change one or both of the subchannel configuration scheme and the channel-coding scheme, using a preamble. Therefore, the present invention can change the subchannel configuration scheme according to a preamble pattern, unlike the prior art in which only the PUSC scheme is used as the subchannel configuration scheme. Alternatively, the present invention can change one, or both of the subchannel configuration scheme and the channel-coding scheme according to a preamble mapping method.

The preamble pattern (preamble code transmitted through each subcarrier) used for changing one, or both of the subchannel configuration scheme and the channel-coding scheme will be described in detail later with reference to the accompanying drawings.

In this manner, the present invention transmits a subchannel configuration scheme and a channel-coding scheme used for a FCH and a downlink/uplink MAP through a preamble regularly transmitted in every downlink frame, thereby removing the need for the conventional fixed operation mode predefined as an initial operation mode. Therefore, the initial operation mode is transmitted through a preamble, and the FCH and the downlink/uplink MAP are decoded using an initial operation mode detected from the preamble. A subchannel configuration scheme and a channel-coding scheme for the next transmission OFDMA symbols are transmitted through the FCH and the downlink/uplink MAP, thereby enabling data decoding.

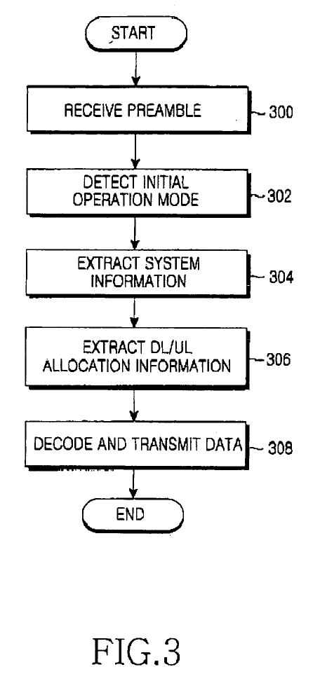

FIG. 3 is a flowchart illustrating an operation of detecting an initial operation mode and performing data decoding on the next transmission symbols in a BWA communication system according to an embodiment of the present invention. Referring to FIG. 3, in step 300, a mobile station receives a preamble from a base station, and then proceeds to step 302. Upon receiving the preamble, the mobile station can acquire information on a subchannel configuration scheme and/or a channel-coding scheme for a FCH that the base station desires to transmit. The mobile station detects an initial operation mode in step 302, and extracts system information in step 304. The system information can be acquired by demodulating and decoding the FCH.

In step 306, the mobile station extracts information allocated to an uplink and a downlink, and then proceeds to step 308. The uplink and downlink information can be extracted using MAP information included in the FCH. In step 308, the mobile station, after extracting the uplink and downlink information, can transmit data through the uplink and decode data received through the downlink.

The present invention proposes three methods of transmitting initial operation mode information through a preamble. The first method transmits initial operation mode information by cyclic-shifting a preamble signal in a time domain and a frequency domain at predetermined intervals or by a predetermined delay time. The second method transmits initial operation mode information by phase-shifting a time-domain preamble pattern occurring when converting each of frequency-domain preamble signals into a time-domain signal through IFFT. The third method transmits initial operation mode information by performing FFT on a PN sequence configured in a frequency domain.

First Method

Herein, a time axis-based embodiment and a frequency axis-based embodiment will be separately described.

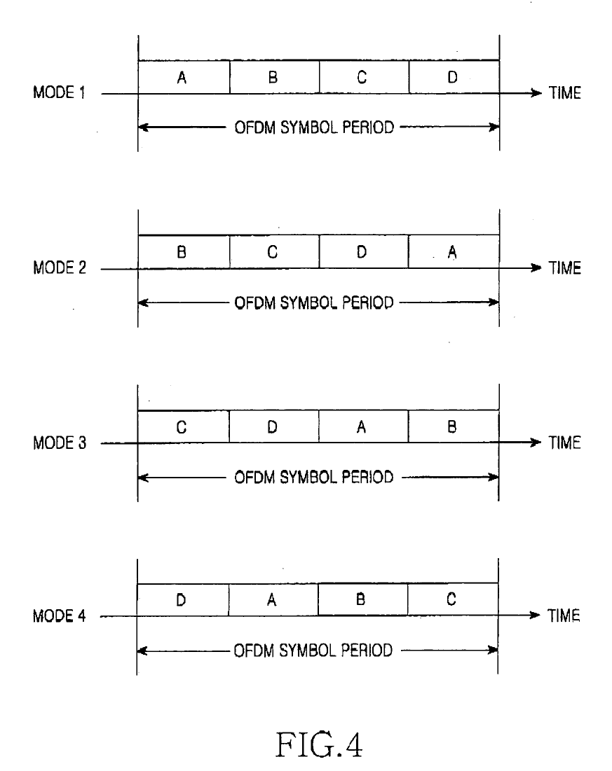

FIG. 4 is a diagram for a description of a method for configuring a preamble in a BWA communication system according to an embodiment of the present invention. Before a description of FIG. 4 is given, it should be noted that a guard interval is omitted because it is not related to the present invention, and it is assumed that there are four possible initial operation modes, by way of example. Therefore, the number of the initial operation modes is subject to change.

Referring to FIG. 4, the four initial operation modes are distinguished by cyclic-shifting a preamble signal in a time axis. It is assumed that an original preamble signal has a pattern of ‘A→B→C→D’ in the time axis. In the following description, a mode based on the original preamble signal will be set as an “Mode #1.” The following initial operation modes #2, #3, and #4 can be obtained by cyclic-shifting or delaying the time-axis (or time-domain) pattern.
Initial Operation Mode #2: B→C→D→A
Initial Operation Mode #3: C→D→A→B
Initial Operation Mode #4: D→A→B→C

In this manner, it is possible to set four initial operation modes for one basic time-domain preamble pattern. This is for the case where the OFDM symbol period is divided into four parts, by way of example. Therefore, the possible number of patterns can be increased. If the preamble pattern is subject to random shifting rather than cyclic shifting, the possible maximum number of patterns is twenty-four. In the following description, it will be assumed that the preamble pattern is subject to cyclic shifting, for the sake of simplicity.

If the time-domain preamble pattern is cyclic-shifted as described above, a frequency-axis (frequency-domain) preamble pattern corresponds to its associated subcarrier index, and is phase-shifted according to the shifted time. This relationship can be expressed as Equation (1):
Ĉₖ=cₖe^{j2πnk/N}_{_{FFT}} (1)
where Ĉₖ denotes a preamble code of a k^{th} subcarrier after being cyclic-shifted, Ck denotes an original preamble code of the k^{th} subcarrier, ‘k’ denotes a subcarrier index, ‘n’ denotes a cyclic-shifted sample, in other words, a delayed sample time, and N_{FFT} denotes a size of fast Fourier transform (FFT) for generating an OFDMA symbol.

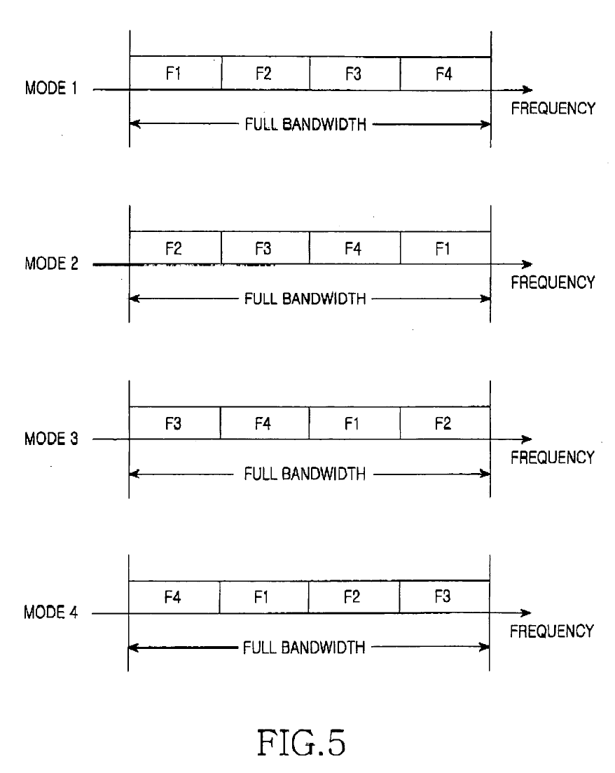

FIG. 5 is a diagram for a description of a method for configuring a preamble in a BWA communication system according to an embodiment of the present invention. Before a description of FIG. 5 is given, it should be noted that the guard interval is omitted as done in FIG. 4, and it is assumed that there are 4 possible initial operation modes, by way of example. Therefore, the number of the initial operation modes is subject to change.

Referring to FIG. 5, the four initial operation modes are distinguished by cyclic-shifting a preamble signal in a frequency axis. It is assumed that an original preamble signal has a pattern of ‘F1, F2, F3, F4’ in the frequency axis. A mode based on the original preamble signal is set as “Mode #1.” A pattern of ‘F2, F3, F4, F1’ obtained by cyclic-shifting the frequency-domain pattern is set as a “Mode #2.” Similarly, a pattern of ‘F3, F4, F1, F2’ obtained by cyclic-shifting the preamble signal is set as a “Mode #3.” Finally, a pattern of ‘F4, F1, F2, F3’ is set as a “Mode #4.” In this manner, it is possible to set four initial operation modes for one frequency-domain preamble pattern. Similarly, the frequency-domain preamble pattern can also be subject to random shifting rather than cyclic shifting.

Although the number of the initial operation modes set according to an embodiment of the present invention is limited to four by way of example, it is subject to change.

It is possible to transmit information on the initial operation modes by transmitting the preambles. Therefore, a mobile station can detect the initial operation mode through a downlink frame transmitted on a first symbol in every frame, and can decode information on a FCH and a downlink/uplink MAP using the detection result.

A description has been made of preamble distinguishing schemes. Subchannel configuration schemes or channel-coding schemes for a FCH can be mapped to the preamble distinguishing schemes, and previously stored as system information. In this case, it is possible to efficiently transmit data without a fixed transmission scheme for the FCH.

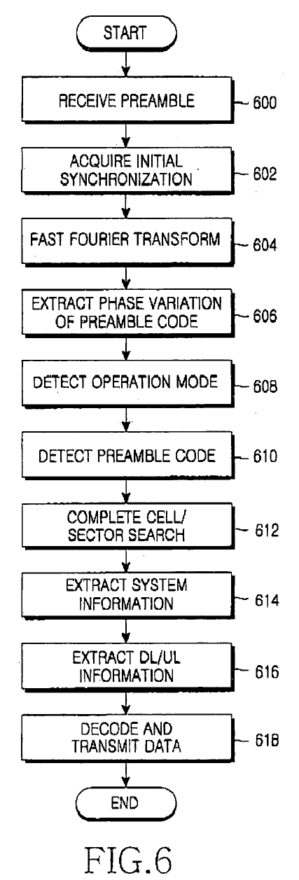

If information on one of predetermined several initial operation modes is carried on a preamble, the mobile station should acquire system information by extracting the initial operation mode information. When initial operation mode information is transmitted through cyclic shifting in a time axis as shown in FIG. 4, or when initial operation mode information is transmitted through cyclic shifting in a frequency axis as shown in FIG. 5, the mobile station should perform an operation of FIG. 6 as a corresponding detection algorithm.

FIG. 6 is a flowchart illustrating an operation of a mobile station in detecting an operation mode from a preamble according to an embodiment of the present invention.

Referring to FIG. 6, the mobile station receives a preamble in step 600, and acquires initial synchronization in step 602. Herein, the acquisition of initial synchronization refers to acquisition of frame synchronization, sampling timing synchronization and frequency synchronization.

In step 604, the mobile station performs FFT. In step 606, the mobile station extracts a phase variation of a preamble pattern due to cyclic shifting in a time domain, i.e., time delay for each preamble pattern, in the case of time-domain cyclic shifting. However, the mobile station extracts a phase variation of a preamble pattern due to cyclic shifting in a frequency domain for each preamble pattern, in the case of frequency-domain cyclic shifting. In this manner, the mobile station detects a phase variation of the preamble pattern. In step 608, the mobile station detects an operation mode mapped to the preamble pattern by recognizing the time-domain or the frequency-domain cyclic shifting. In step 610, the mobile station detects a preamble code.

The mobile station completes a cell/sector search in step 612, and extracts system information in step 614. In step 616, the mobile station extracts information allocated to a downlink and an uplink, and then proceeds to step 618. Herein, the downlink and uplink information can be extracted using information included in the FCH. In step 618, the mobile station, after extracting the uplink and downlink information, can transmit data through the uplink and decode data received through the downlink.

With reference to FIG. 6, a description has been made of a method of applying various preamble patterns using the time-domain and frequency-domain cyclic shifting. Therefore, operation of the time-domain and frequency-domain cyclic shifting are both illustrated in FIG. 6.

As illustrated in FIG. 6, basically, a preamble is transmitted by selecting one of several patterns (codes in a frequency axis) according to a cell/sector identifier (ID) such that a cell/sector can be distinguished. This is possible because a unique preamble is set for each base station in an OFDMA system, as in a Code Division Multiple Access (CDMA) mobile communication system in which a unique PN sequence is set for each base station. Therefore, if the time-domain cyclic shifting method or the frequency-domain cyclic shifting method is used to additionally transmit initial operation mode information, the number of the preamble patterns increases to a multiple of the number of possible combinations of initial operation modes, and the mobile station should distinguish all of the preamble patterns. The preamble patterns can be distinguished by the conventional preamble detection method, and a detailed description thereof will be omitted herein since it is know in the art.

Second Method

The second method is a method for transmitting initial operation mode information through phase shifting of a time-domain preamble pattern.

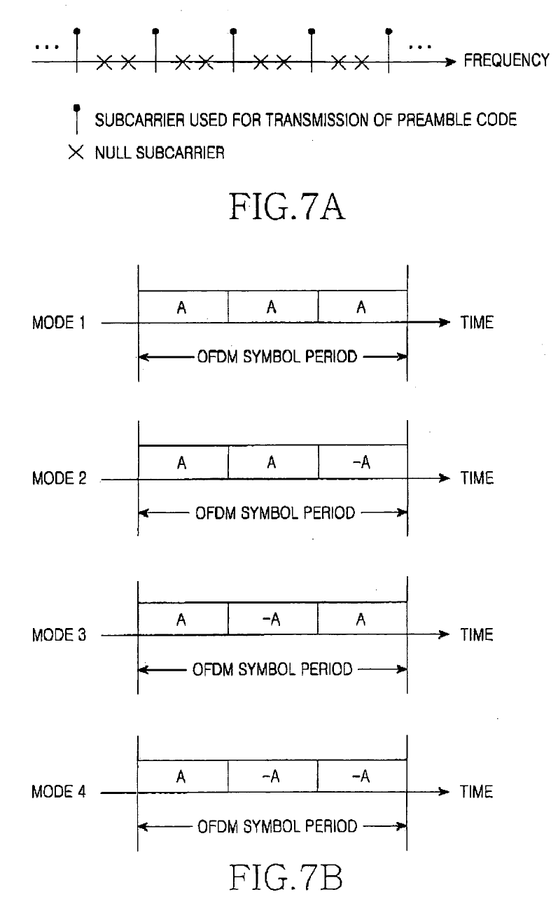

With reference to FIGS. 7A and 7B, a description will be made of a method for configuring a preamble by shifting a phase of a time-domain preamble pattern by 0° or 180°.

Before a description of FIGS. 7A and 7B is given, it should be noted that a guard interval is omitted because it is not related to the present invention, and it is assumed that there are four possible initial operation modes, by way of example. Therefore, the number of the initial operation modes is subject to change.

FIG. 7A is a diagram illustrating an example of a method for mapping preamble signals to subcarriers according to an alternative embodiment of the present invention. Referring to FIG. 7A, a mapping relationship between preamble codes and subcarriers used for transmitting the preamble codes is shown. With reference to FIGS. 7A and 7B, a description will be made of a method for shifting a phase of preamble patterns.

FIG. 7B is a diagram illustrating a method for configuring a preamble in a BWA communication system according to an alternative embodiment of the present invention. Referring to FIG. 7B, when the preamble codes are mapped to the subcarriers in the method of FIG. 7A, the same patterns are repeated three times. Therefore, four preamble patterns can be obtained for one basic time-domain preamble pattern by shifting the phase of the time-domain preamble pattern by 0° or 180°. FIG. 7B shown different operation modes set by time-domain preamble signals repeated three times according to an initial operation mode.

The time-domain preamble signal pattern is repeated three times according to the initial operation mode, and four operation modes are distinguished by phase shifts of (0°, 0°, 0°), (0°, 0°, 180°), (0°, 180°, 0°) and (0°, 180°, 180°).

It is assumed that an original preamble signal has a pattern repeated three times in the manner of ‘(A)→(A)→(A)’. A mode based on the original preamble signal is set as a “Mode #1.” The following initial operation modes #2, #3, and #4 can be obtained by phase-shifting the time-domain pattern.
Initial Operation Mode #2: (A)→(A)→(−A)
Initial Operation Mode #3: (A)→(−A)→(A)
Initial Operation Mode #4: (A)→(−A)→(−A)

In this manner, four initial operation modes can be set for one basic time-domain preamble pattern. It is assumed herein that a preamble pattern is repeated three times and the phase is shifted by 180°. Therefore, an increase in the degree of phase shifting and the number of repetitions of the preamble pattern may increase the possible number of patterns. That is, it is possible to obtain the increased number of combinations by phase-shifting the preamble pattern by, for example, 45° and 90° in addition to 0° and 180°.

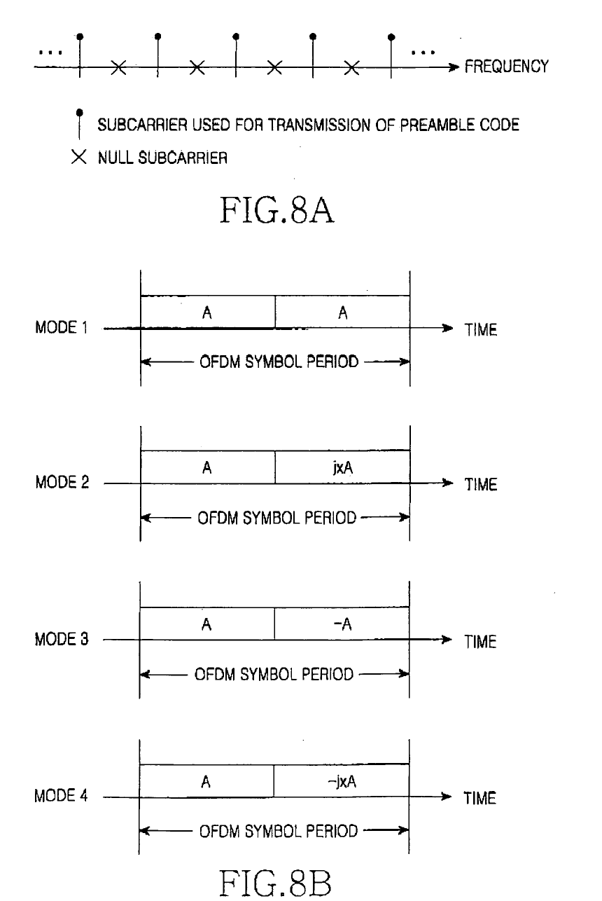

Next, with reference to FIGS. 8A and 8B, a description will be made of a method for configuring a preamble by phase-shifting a time-domain preamble pattern by 0°, 90°, 180° and 270°.

Before a description of FIGS. 8A and 8B is given, it should be noted that a guard interval is omitted because it is not related to the present invention, and it is assumed that there are four possible initial operation modes, by way of example. Therefore, the number of the initial operation modes is subject to change.

FIG. 8A is a diagram illustrating an example of a method for mapping preamble signals to subcarriers according to an alternative embodiment of the present invention. Referring to FIG. 8A, a mapping relationship between preamble codes and subcarriers used for transmitting the preamble codes is shown. With reference to FIGS. 8A and 8B, a description will be made of a method for shifting preamble pattern phases.

FIG. 8B is a diagram illustrating a method for configuring a preamble in a BWA communication system according to an alternative embodiment of the present invention. Referring to FIG. 8B, when the preamble codes are mapped to the subcarriers in the method of FIG. 8A, the same patterns are repeated two times in a time domain. Therefore, four preamble patterns can be obtained for one basic time-domain preamble pattern by shifting a phase of the time-domain preamble pattern by 0°, 90°, 180° and 270°. FIG. 8B shows different operation modes set by time-domain preamble signals repeated two times according to an initial operation mode.

The time-domain preamble signal pattern is repeated two times according to an initial operation mode, and four operation modes are distinguished by shifting phases by (0°, 0°), (0°, 90°), (0°, 180°) and (0°, 270°). It is assumed that the original preamble signal has a pattern repeated two times in the time axis in the manner of ‘(A)→(A)’. A mode based on the original preamble signal is set as Mode #1.” The following initial operation modes #2, #3, and #4 can be obtained by phase-shifting the time-domain pattern.
Initial Operation Mode #2: (A)→(j×A)
Initial Operation Mode #3: (A)→(−A)
Initial Operation Mode #4: (A)→(−j×A)

Herein, ‘j’ denotes an imaginary number, a radical root of −1.

Similarly, it is possible to express a plurality of initial operation modes for one basic time-domain preamble pattern using a method similar to that of FIGS. 7A and 7B. Although the number of the initial operation modes set according to an alternative embodiment of the present invention is limited to four by way of example, it is subject to change.

It is possible to transmit information on the initial operation modes by transmitting the preambles. Therefore, a mobile station can detect the initial operation mode through a downlink frame transmitted on a first symbol in every frame, and can decode information on a FCH and a downlink/uplink MAP using the detected result.

With reference to FIGS. 7A to 8B, a description has been made of preamble distinguishing schemes. Subchannel configuration schemes or channel-coding schemes for a FCH can be mapped to the preamble distinguishing schemes, and previously stored as system information. In this case, it is possible to efficiently transmit data without the necessity of transmitting the data according to a fixed transmission scheme for the FCH.

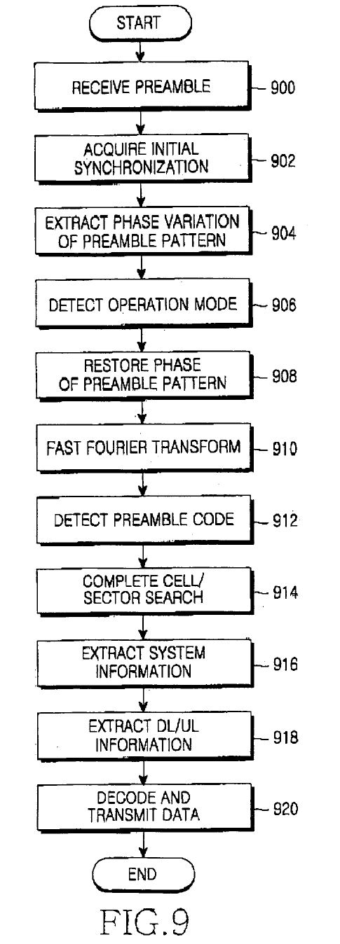

If information on several initial operation modes is carried in a preamble, the mobile station acquires system information by extracting the initial operation mode information. When initial operation mode information is transmitted through phase shifting of preamble patterns as shown in FIGS. 7A to 8B, the mobile station performs an operation of FIG. 9 as a corresponding detection algorithm.

FIG. 9 is a flowchart illustrating an operation for detecting an operation mode from a preamble pattern configured by phase-shifting the preamble pattern in a BWA communication system according to an alternative embodiment of the present invention.

Referring to FIG. 9, the mobile station receives a preamble in step 900, and acquires initial synchronization in step 902. Herein, the acquisition of initial synchronization refers to acquisition of frame synchronization, sampling timing synchronization and frequency synchronization. In step 904, the mobile station extracts a phase variation of the preamble pattern.

In step 906, the mobile station detects an operation mode by recognizing the variation in phase, occurred during generation of the preamble. In step 908, the mobile station restores a phase of a time-domain preamble pattern. In step 910, the mobile station performs Fourier transform. In step 912, the mobile station detects a preamble code.

The mobile station completes cell/sector search in step 914, and extracts system information in step 916. In step 918, the mobile station extracts downlink and uplink information. In step 920, the mobile station transmits data through the uplink and decodes data received through the downlink.

As illustrated in FIG. 9, basically, a preamble is transmitted by selecting one of several patterns (codes in a frequency axis) according to a cell/sector ID such that a cell/sector can be distinguished. This is possible because a unique preamble is set for each base station in an OFDMA system, as in a CDMA mobile communication system in which a unique PN sequence is set for each base station.

Therefore, the second method phase-shifts a preamble pattern repeated in a time domain to transmit initial operation mode information. In this case, an initial operation mode can be detected by simply detecting the number of initial operation modes that the preamble sequence has in the time domain, i.e., the number of phase-shifted combinations.

In this manner, the mobile station can detect an initial operation mode and a cell/sector without an increase in complexity.

Third Method

The third method is a method for transmitting initial operation mode information using a PN sequence.

The present invention generates a preamble signal by performing IFFT on a PN sequence configured in a frequency domain, and uniquely configures a PN sequence used for the preamble signal according to each initial operation mode.

For convenience, it will be assumed herein that there are four possible initial operation modes, by way of example. It should be noted that the number of the initial operation modes is subject to change.

If the number of initial operation modes that should be distinguished is four, the preambles are configured using 4 PN sequences and the initial operation modes are expressed with the preambles. In this case, a preamble signal is obtained by performing IFFT on a PN sequence selected for each initial operation mode.

A description will now be made of preamble signal configurations for initial operation modes on the assumption that four PN sequences are selected.
PN sequence #1=1, −1, 1, 1, −1, −1, 1, 1, . . .
PN sequence #2=1, 1, 1, −1, 1, −1, 1, 1, . . .
PN sequence #3=−1, 1, −1, 1, 1, 1, 1, −1, . . .
PN sequence #4=1, −1, −1, −1, 1, −1, 1, −1, . . .

If the number of initial operation modes that should be distinguished is 4, the PN sequences are mapped to the initial operation modes on a one-to-one basis.

In other words, the PN sequence #1 is mapped to the initial operation mode #1, the PN sequence #2 is mapped to the initial operation mode #2, the PN sequence #3 is mapped to the initial operation mode #3, and the PN sequence #4 is mapped to the initial operation mode #4. In this manner, the initial operation modes can be acquired, and preamble patterns can be configured by mapping different preamble sequences to the initial operation modes.

Although the number of the initial operation modes for distinguishing subchannel configuration schemes, set according to a further alternative embodiment of the present invention, is limited to four by way of example, that number may change. That is, it is possible to configure as many preambles as the number of initial operation modes. The preamble configuring method is given by way of example. The PN sequences used for the embodiment of the present invention are also given by way of example, and other PN sequences can be used. In addition, the preambles can be configured taking even the channel-coding schemes into consideration. In this case, if there are 4 subchannel configuration schemes and four channel-coding schemes, all of 16 preamble sequences can be distinguished using the PN sequences.

It is possible to transmit information on the initial operation modes by transmitting the preambles. Therefore, a mobile station can detect the initial operation mode through a downlink frame transmitted on a first symbol in every frame, and can decode information on a FCH and a downlink/uplink MAP using the detected result.

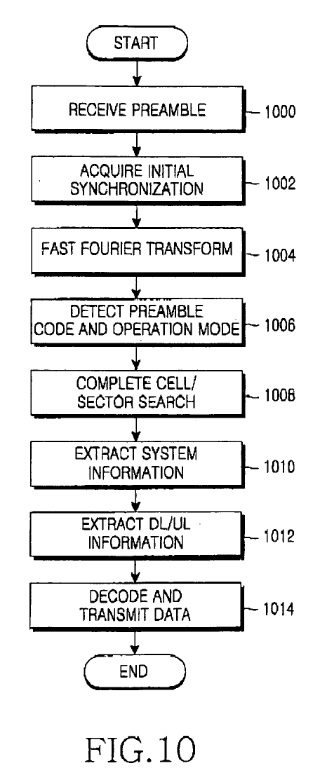

When the PN sequences are used, the mobile station should perform an operation of FIG. 10 as a corresponding detection algorithm.

FIG. 10 is a flowchart illustrating an operation of detecting an operation mode using PN sequences in a BWA communication system according to a further alternative embodiment of the present invention.

Referring to FIG. 10, the mobile station receives a preamble in step 1000, and acquires initial synchronization in step 1002. Herein, the acquisition of initial synchronization refers to acquisition of frame synchronization, sampling timing synchronization and frequency synchronization. In step 1004, the mobile station performs FFT. In step 1006, the mobile station detects an operation mode and a preamble code for distinguishing operation modes and base stations, and then proceeds to step 1008. That is, the detection of the preamble code refers to a process of extracting a PN sequence for distinguishing an operation mode and detecting an operation mode mapped to the PN sequence.

The mobile station completes celusector search in step 1008, and extracts system information in step 1010. In step 1012, the mobile station extracts downlink and uplink information. In step 1014, the mobile station transmits data through the uplink and decodes data received through the downlink.

As illustrated in FIG. 10, basically, a preamble is transmitted by selecting one of several patterns (codes in a frequency axis) according to a cell/sector ID such that a celusector can be distinguished. This is possible because a unique preamble is set for each base station in an OFDMA system, as in a CDMA mobile communication system in which a unique PN sequence is set for each base station.

Therefore, the third method uses PN sequences configured in a frequency domain to transmit initial operation mode information.

As described above, the present invention provides three methods of determining initial operation modes using preamble signals, and the foregoing embodiments are given by way of example. The operation modes are not limited to the subchannel confirmation schemes and the channel-coding schemes for the frame transmitted in a downlink frame period.

According to the above-mentioned three methods, a preamble pattern is determined in advance and is selected out of the preamble patterns. As such, the preamble pattern is mapped to the operation mode and the preamble is constructed using the selected preamble pattern. Thus, it is possible to determine the operation mode by transmitting/receiving the preamble. Herein, a receiving part receiving the preamble should store previously information for detecting the operation mode.

The novel method can be implemented by software and then stored on storage media (CD-ROM, RAM, floppy disk, hard disk, magneto-optical (MO) disk, etc.) that can be read by a computer.

As can be understood from the foregoing description, the novel method transmits operation mode information to a mobile station using a preamble without fixing an initial operation mode in a BWA communication system, thereby flexibly implementing design and application of the operation modes. In this manner, it is possible to enable various operation modes in the BWA communication system.

While the invention has been shown and described with reference to a certain preferred embodiment thereof, it will be understood by those skilled in the art that various changes in form and details may be made therein without departing from the spirit and scope of the invention as defined by the appended claims.

1. A method for transmitting/receiving operation mode information in a broadband wireless access (BWA) communication system, the method comprising the steps of:
mapping a predetermined preamble pattern to an operation mode, and upon a change in the operation mode, transmitting a preamble pattern corresponding to the change;
receiving the preamble pattern, detecting the operation mode and a preamble code mapped to the preamble pattern, and acquiring information from a frame section received according to the operation mode.

2. The method of claim 1, wherein the operation mode includes one or both of a subchannel configuration scheme and a channel-coding scheme for a frame transmitted for a downlink frame period.

3. The method of claim 1, wherein the preamble pattern is generated by cyclic-shifting a predetermined number of preamble signals in a time domain according to the operation mode.

4. The method of claim 1, wherein the preamble pattern is generated by cyclic-shifting a predetermined number of preamble signals in a frequency domain according to the operation mode.

5. The method of claim 1, wherein the preamble pattern is generated by randomly configuring a predetermined number of preamble signals according to the operation mode.

6. The method of claim 1, wherein the preamble pattern is generated by shifting a phase of a time-domain preamble pattern.

7. The method of claim 1, wherein the preamble pattern is generated by performing an inverse fast Fourier transform on a pseudo-random noise (PN) sequence configured in a frequency domain.

8. The method of claim 1, wherein the operation mode and the preamble code are detected by performing a fast Fourier transform on a preamble pattern and detecting a phase variation of a preamble code due to cyclic shifting in a time domain.

9. The method of claim 1, wherein the operation mode and the preamble code are detected by performing a fast Fourier transform on a preamble pattern and detecting a phase variation of a preamble code due to cyclic shifting in a frequency domain.

10. The method of claim 1, wherein the step of detecting an operation mode and a preamble code comprises the step of detecting the operation mode by extracting a phase variation of a time-domain preamble pattern and detecting the preamble code by performing a fast Fourier transform after phase-restoring a preamble pattern.

11. The method of claim 1, wherein the operation mode and the preamble code are detected by performing a fast Fourier transform on a preamble pattern and restoring a phase of the preamble pattern.

12. A method for transmitting operation mode information in a broadband wireless access (BWA) communication system, the method comprising the steps of:
predetermining a group of preamble pattern by cyclic-shifting a preamble signal in a time domain;
selecting one of the predetermined preamble pattern according to an operation mode and mapping to the operation mode;
generating a preamble using the selected preamble pattern; and
transmitting the preamble.

13. The method of claim 12, wherein the operation mode includes one or both of a subchannel configuration scheme and a channel-coding scheme for a frame transmitted for a downlink frame period.

14. A method for receiving operation mode information in a broadband wireless access (BWA) communication system, the method comprising the steps of:
receiving a preamble and performing a fast Fourier transform on the preamble;
detecting an operation mode by extracting a phase variation from a preamble code obtained by cyclic-shifting a preamble pattern in a time domain; and
detecting a preamble code, and acquiring information from a frame section using the operation mode and the preamble code.

15. The method of claim 14, wherein the operation mode includes one or both of a subchannel configuration scheme and a channel-coding scheme for a frame transmitted for a downlink frame period.

16. A method for transmitting operation mode information in a broadband wireless access (BWA) communication system, the method comprising the steps of:
predetermining a group of preamble pattern by cyclic-shifting a preamble signal in a frequency domain;
selecting one of the predetermined preamble pattern according to an operation mode and mapping to the operation mode;
generating a preamble using the selected preamble pattern; and
transmitting the preamble.

17. The method of claim 16, wherein the operation mode includes one or both of a subchannel configuration scheme and a channel-coding scheme for a frame transmitted for a downlink frame period.

18. A method for receiving operation mode information in a broadband wireless access (BWA) communication system, the method comprising the steps of:
receiving a preamble and performing a fast Fourier transform on the received preamble;
detecting an operation mode by extracting a phase variation from a preamble code obtained by cyclic-shifting a preamble pattern in a frequency domain; and
detecting a preamble code, and acquiring information from a frame section using the operation mode and the preamble code.

19. The method of claim 18, wherein the operation mode includes one or both of a subchannel configuration scheme and a channel-coding scheme for a frame transmitted for a downlink frame period.

20. A method for transmitting operation mode information in a broadband wireless access (BWA) communication system, the method comprising the steps of:
selecting one of the predetermined a preamble pattern through phase shifting;
selecting the preamble pattern according to an operation mode and mapping the operation mode;
generating a preamble using the selected preamble pattern; and
transmitting the preamble.

21. The method of claim 20, wherein the operation mode includes one or both of a subchannel configuration scheme and a channel-coding scheme for a frame transmitted for a downlink frame period.

22. The method of claim 20, wherein the phase shifting is achieved by one or more angles set for each of preamble signals.

23. A method for receiving operation mode information in a broadband wireless access (BWA) communication system, the method comprising the steps of:
detecting an operation mode by receiving a preamble and extracting a phase variation of a preamble pattern;
restoring a phase of the preamble pattern; and
detecting a preamble code by performing a fast Fourier transform on the phase-restored preamble pattern, and acquiring information from a frame section using the operation mode and the preamble code.

24. The method of claim 23, wherein the operation mode includes one or both of a subchannel configuration scheme and a channel-coding scheme for a frame transmitted for a downlink frame period.

25. A method for transmitting operation mode information in a broadband wireless access (BWA) communication system, the method comprising the steps of:
generating a group of preamble pattern by performing an inverse fast Fourier transform on a pseudo-random noise (PN) sequence configured in a frequency domain;
selecting a preamble pattern according to an operation mode and mapping the determined preamble pattern to the operation mode;
generating a preamble using the selected preamble pattern; and
transmitting the preamble.

26. The method of claim 25, wherein the operation mode includes one or both of a subchannel configuration scheme and a channel-coding scheme for a frame transmitted for a downlink frame period.

27. A method for receiving operation mode information in a broadband wireless access (BWA) communication system, the method comprising the steps of:
receiving a preamble and performing a fast Fourier transform on the received preamble;
detecting a preamble code and an operation mode by extracting a pseudo-random noise (PN) sequence constituting a preamble pattern; and
acquiring information from a frame section received according to the operation mode using the operation mode and the preamble code.

28. The method of claim 27, wherein the operation mode includes one or both of a subchannel configuration scheme and a channel-coding scheme for a frame transmitted for a downlink transmission period.
